(19) United States
(12) Patent Application Publication
(10) Pub. No.: US 2021/0096368 A1
(43) Pub. Date: Apr. 1, 2021

(54) HEAD-MOUNTED DISPLAY APPARATUS AND METHOD EMPLOYING DYNAMIC EYE CALIBRATION

(71) Applicant: Varjo Technologies Oy, Helsinki (FI)

(72) Inventors: Thomas Carlsson, Vantaa (FI); Ville Miettinen, Helsinki (FI)

(21) Appl. No.: 16/585,900

(22) Filed: Sep. 27, 2019

(51) Int. Cl. G02B 27/01

(52) U.S. Cl. CPC G02B 27/0172; G02B 2027/0187; G02B 2027/0138; G02B 2027/014

(57) ABSTRACT

A head-mounted display apparatus comprising image renderer, camera, and processor. The processor is configured to: control image renderer to render reference images whilst controlling camera to capture images of user's eyes, each reference image presenting a visual target at corresponding location and optical depth within field of view of user; analyze image of user's eyes that was captured when given reference image was being rendered, to determine gaze directions of user's eyes; and determine, based on gaze directions and location of given visual target presented by given reference image, ocular dominance of user at given optical depth of given visual target. The processor or an imaging unit is configured to generate, based on ocular dominance of user at given optical depth, sequence of extended-reality images to be rendered via image renderer.

### TECHNICAL FIELD

The present disclosure relates generally to display apparatuses; and more specifically, to head-mounted display apparatuses comprising image renderers, cameras, and processors. Moreover, the present disclosure also relates to methods of using the aforesaid head-mounted display apparatuses.

### BACKGROUND

Presently, several technologies (for example, such as virtual reality (VR), augmented reality (AR), mixed reality (MR) and extended reality (XR)) are being used to present interactive simulated environments to users. The users utilize specialized Head-Mounted Devices (HMDs) for experiencing and interacting with such simulated environments. Conventional HMDs display images that collectively constitute such simulated environments, to the user. When such images are captured according to gaze directions of the user's eyes, the simulated environments would appear realistic to the user.

However, accurately determining the gaze directions of the user's eyes is extremely difficult. This can be primarily attributed to the fact that eyes of different users are different, and therefore respond differently to same visual input. Approximately 1 percent to 2 percent of human population suffers from anomalous medical conditions of the eyes (for example, such as strabismus). Notably, a manner in which eyes of a given user suffering from such medical conditions would respond to a given visual input is different from a manner in which healthy eyes of another user would respond to the given visual input.

Moreover, existing generic (namely, for all users irrespective of taking into account their medical conditions) calibration solutions employed in HMDs for gaze tracking are inaccurate and tend to overcompensate for errors by using arduous static calibrations (as they lack dynamic optimization capabilities). Since the generic calibration solutions are mass market solutions, they lack provision for user-specific optimization. This subsequently leads to inaccuracies in gaze detection. When the inaccurate gaze directions are utilized to present the simulated environments to the users suffering from the medical conditions, said users experience unrealism, lack of immersion, and abstractedness within the simulated environments. This considerably reduces the users experience of using the HMDs, and may also cause eye fatigue, dizziness, and the like. Therefore, the users suffering from the medical conditions are currently under-served by existing HMDs.

Therefore, in light of the foregoing discussion, there exists a need to overcome the aforementioned drawbacks associated with conventional HMDs employing generic calibration solutions for gaze tracking.

### SUMMARY

The present disclosure seeks to provide a head-mounted display apparatus. The present disclosure also seeks to provide a method. The present disclosure seeks to provide a solution to the existing problem of inaccurate gaze tracking in existing Head-Mounted Devices. An aim of the present disclosure is to provide a solution that overcomes at least partially the problems encountered in prior art, and provides a head-mounted display apparatus that accurately determines gaze directions of a user's eyes, and effectively utilizes the determined gaze directions to present immersive extended-reality environments to the user.

In one aspect, an embodiment of the present disclosure provides a head-mounted display apparatus comprising:
at least one image renderer;
at least one camera; and
at least one processor configured to:
   control the at least one image renderer to render a sequence of reference images, whilst controlling the at least one camera to capture images of a user's eyes, wherein each reference image of said sequence presents to the user a visual target at a corresponding location and a corresponding optical depth within a field of view of the user;
   analyze at least one image of the user's eyes that was captured when a given reference image was being rendered, to determine gaze directions of the user's eyes; and
   determine, based on the determined gaze directions of the user's eyes and a given location of a given visual target within the field of view presented by the given reference image, an ocular dominance of the user at a given optical depth at which the given visual target was being presented by the given reference image,
      wherein the at least one processor or an imaging unit communicably coupled to the at least one processor is configured to generate, based on the ocular dominance of the user at the given optical depth, a sequence of extended-reality images to be rendered via the at least one image renderer.

In another aspect, an embodiment of the present disclosure provides a method comprising:
rendering a sequence of reference images, whilst capturing images of a user's eyes, wherein each reference image of said sequence presents to the user a visual target at a corresponding location and a corresponding optical depth within a field of view of the user;
analyzing at least one image of the user's eyes that was captured when a given reference image was being rendered, to determine gaze directions of the user's eyes;
determining, based on the determined gaze directions of the user's eyes and a given location of a given visual target within the field of view presented by the given reference image, an ocular dominance of the user at a given optical depth at which the given visual target was being presented by the given reference image; and
generating, based on the ocular dominance of the user at the given optical depth, a sequence of extended-reality images to be rendered.

Embodiments of the present disclosure substantially eliminate or at least partially address the aforementioned problems in the prior art, and enable accurate gaze detection of a user, which subsequently allows for presenting realistic gaze-contingent extended-reality images to the user.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1, 2 and 3 illustrate block diagrams of architectures of a head-mounted display apparatus, in accordance with various embodiments of the present disclosure;

FIGS. 4A and 4B illustrate ocular dominance of a user's eyes, in accordance with an embodiment of the present disclosure; and

FIG. 5 illustrates steps of a method, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a head-mounted display apparatus comprising:
at least one image renderer;
at least one camera; and
at least one processor configured to:
   control the at least one image renderer to render a sequence of reference images, whilst controlling the at least one camera to capture images of a user's eyes, wherein each reference image of said sequence presents to the user a visual target at a corresponding location and a corresponding optical depth within a field of view of the user;
   analyze at least one image of the user's eyes that was captured when a given reference image was being rendered, to determine gaze directions of the user's eyes; and
   determine, based on the determined gaze directions of the user's eyes and a given location of a given visual target within the field of view presented by the given reference image, an ocular dominance of the user at a given optical depth at which the given visual target was being presented by the given reference image,
      wherein the at least one processor or an imaging unit communicably coupled to the at least one processor is configured to generate, based on the ocular dominance of the user at the given optical depth, a sequence of extended-reality images to be rendered via the at least one image renderer.

In another aspect, an embodiment of the present disclosure provides a method comprising:
rendering a sequence of reference images, whilst capturing images of a user's eyes, wherein each reference image of said sequence presents to the user a visual target at a corresponding location and a corresponding optical depth within a field of view of the user;
analyzing at least one image of the user's eyes that was captured when a given reference image was being rendered, to determine gaze directions of the user's eyes;
determining, based on the determined gaze directions of the user's eyes and a given location of a given visual target within the field of view presented by the given reference image, an ocular dominance of the user at a given optical depth at which the given visual target was being presented by the given reference image; and
generating, based on the ocular dominance of the user at the given optical depth, a sequence of extended-reality images to be rendered.

The present disclosure provides the aforementioned head-mounted display apparatus and the aforementioned method. The display apparatus employs a customized user-specific calibration solution for gaze tracking. In the display apparatus, dynamic user experience responses are taken into account whilst calibrating the head-mounted display apparatus for the user. The dynamic user experience responses pertain to the determined ocular dominance of the user at optical depth(s) at which the visual target is presented in the sequence of reference images. As a result of said calibration, subsequently determined gaze directions of the user's eyes are extremely accurate. Said gaze directions can optionally be used for accurate simulation testing, advertising market research, heatmap generation, and the like. When the sequence of extended-reality images is generated based on said calibration and is shown to the user, the user experiences considerable realism, immersion and involvement therein. The display apparatus can be easily used by users suffering from medical conditions as the customized user-specific calibration solution dynamically recognizes such medical conditions (by analyzing the at least one image of the user's eyes and determining the ocular dominance of the user) and generates the sequence of extended-reality images to effectively ameliorate such medical conditions.

Throughout the present disclosure, the term “head-mounted display apparatus” refers to a specialized equipment that is configured to present an extended-reality environment to the user when the head-mounted display apparatus in operation is worn by the user on his/her head. In such an instance, the head-mounted display apparatus acts as a device (for example, such as a virtual reality headset, a pair of virtual reality glasses, an augmented reality headset, a pair of augmented reality glasses, a mixed reality headset, a pair of mixed reality glasses, and the like) that is operable to present a visual scene of the extended-reality environment to the user. Hereinafter, the term “head-mounted display apparatus” is referred to as “display apparatus”, for the sake of convenience only.

Throughout the present disclosure, the term “extended-reality” encompasses virtual reality, augmented reality, mixed reality, and the like.

In one embodiment, the sequence of extended-reality images to be rendered via the at least one image renderer is a sequence of virtual-reality images. The sequence of virtual-reality images, when rendered, presents a visual scene of a virtual reality environment to the user.

In another embodiment, the sequence of extended-reality images to be rendered via the at least one image renderer is a sequence of augmented-reality images. The sequence of augmented-reality images, when rendered, presents a visual scene of an augmented reality environment to the user.

In yet another embodiment, the sequence of extended-reality images to be rendered via the at least one image renderer is a sequence of mixed-reality images. The sequence of mixed-reality images, when rendered, presents a visual scene of a mixed reality environment to the user.

Throughout the present disclosure, the term “image renderer” refers to equipment that, in operation, renders the sequence of extended-reality images that are to be displayed to the user of the display apparatus. Optionally, the at least one image renderer is implemented as at least one display. Optionally, the at least one image renderer is implemented as at least one projector. In this regard, the sequence of extended-reality images is projected onto at least one projection screen or directly onto retinas of the user's eyes.

In some implementations, separate image renderers are used to render the sequence of extended-reality images for left and right eyes of the user. In such implementations, a given extended-reality image is processed to generate separate left and right extended-reality images, wherein the separate left and right extended-reality images are rendered on the separate image renderers. In other implementations, a single image renderer is used to render the sequence of extended-reality images for both the left and right eyes of the user on a shared basis. This potentially reduces the cost of the display apparatus, whilst making the display apparatus more compact and more energy efficient, as compared to a case where the display apparatus has separate image renderers for the left and right eyes of the user. It will be appreciated that both the aforesaid implementations allow for rendering different views of each extended reality image as separate viewports for both eyes of the user, thereby, accurately creating an illusion of stereoscopic depth in the extended-reality environment.

It will be appreciated that the same image renderer is used to render the sequence of reference images as well as the sequence of extended-reality images. Optionally, the sequence of reference images is rendered prior to rendering the sequence of extended-reality images.

Throughout the present disclosure, the term “camera” refers to equipment that is operable to detect and process light reflected from the user's eyes, so as to capture the images of the user's eyes. Optionally, the at least one camera comprises a camera chip, wherein the light reflected from the user's eyes is directed by at least one optical element onto a photosensitive surface of the camera chip, thereby enabling the at least one camera to capture the images of the user's eyes.

In some implementations, separate cameras are used to capture separate images of a left eye and a right eye of the user. In other implementations, a single camera is used to capture a single image of both the left and right eyes of the user.

Throughout the present disclosure, the term “processor” refers to hardware, software, firmware or a combination of these. The at least one processor controls operation of the display apparatus. It will be appreciated that the term “at least one processor” refers to “one processor” in some implementations, and “a plurality of processors” in other implementations.

The at least one processor controls the at least one image renderer to render the sequence of reference images, whilst controlling the at least one camera to capture the images of the user's eyes. The captured images of the user's eyes are representative of a manner in which the user's eyes view the sequence of reference images being rendered by the at least one image renderer. Herein, the term “reference image” refers to an image that is to be used for calibrating the display apparatus according to the user's eyes. In other words, a given reference image acts as a reference using which the display apparatus is calibrated for the user's eyes.

Each reference image of said sequence presents to the user the visual target at the corresponding location and the corresponding optical depth within the field of view of the user. Herein, the term “visual target” refers to a visible mark (namely, spot) presented within a given reference image. Notably, the visual target is distinctly visible in the given reference image. In the given reference image, the visual target may be presented at a central portion of the field of view, at a corner portion of the field of view, and the like. In the given reference image, the visual target may be presented at an optical depth of 10 centimeters, 50 centimeters, 100 centimeters, and the like.

Optionally, each reference image of the sequence of reference images presents to the user a same visual target. Alternatively, optionally, different reference images of the sequence of reference images present to the user different visual targets.

Optionally, a brightness of the visual target is greater than a brightness of a remaining region of the given reference image. This allows for the visual target to be easily and distinctly visible with respect to remaining region of the given reference image.

Alternatively, optionally, a brightness of the visual target is lesser than a brightness of a remaining region of the given reference image.

Optionally, a size of the visual target in the given reference image is selected to be such that the visual target is easily visible to the user. More optionally, the size of the visual target is selected to be larger with respect to size(s) of other object(s) presented in the given reference image.

Optionally, a shape of the visual target in the given reference image is circular, elliptical, polygonal, or a freeform shape.

Optionally, the reference images are rendered in a predefined sequence. Optionally, the predefined sequence is defined by the at least one processor. When the reference images are rendered in the predefined sequence, a specific predefined trajectory of the visual target is presented to the user.

In an embodiment, the sequence of reference images comprises a plurality of reference images that, when rendered, present to the user a same visual target at a same location, but different optical depths, within the field of view of the user. When the user views said plurality of reference images, the same visual target appears to move closer to or away from the user.

As an example, the at least one image renderer may render 3 reference images P1, P2, and P3. Each of the three reference images P1-P3 present a circular yellow-colored visual target. However, different reference images may represent said visual target at a same location, but different optical depths. For example, the reference images P1, P2, and P3 may represent the visual target at a center of the field of view, but at optical depths of X1 units, X2 units and X3 units, respectively.

When X1 is greater than X2, and X2 is greater than X3:
if the reference images P1-P3 are rendered in a sequence of: P1, P2, P3, the visual target would appear to move closer to the user; or
if the reference images P1-P3 are rendered in a sequence of: P3, P2, P1, the visual target would appear to move away from the user.

In another embodiment, the sequence of reference images comprises a plurality of reference images that, when rendered, present to the user a same visual target at different locations, but at a same optical depth, within the field of view of the user. When the user views said plurality of reference images, the same visual target appears to move around within a single plane, wherein the single plane extends along the optical depth at which the visual target is presented.

As an example, the at least one image renderer may render 4 reference images Q1, Q2, Q3, and Q4. Each of the four reference images Q1-Q4 represents a polygonal black-colored visual target. However, different reference images may represent said visual target at different locations, but at a same optical depth. For example, the reference images Q1, Q2, Q3, and Q4 may represent the visual target at the same optical depth of 50 centimeters, but at a top portion of the field of view, a right portion of the field of view, a bottom portion of the field of view, and a left portion of the field of view, respectively. When the reference images Q1-Q4 are rendered in a sequence of: Q1, Q2, Q3, and Q4, the visual target would appear to move clockwise in the field of view.

In yet another embodiment, the sequence of reference images comprises a plurality of reference images that, when rendered, present to the user a same visual target at different locations and different optical depths within the field of view of the user. When the user views said plurality of reference images, the same visual target appears to move around across different locations and optical depths within the field of view of the user. Notably, in such a case, the visual target appears to move across three dimensions of the field of view.

As an example, the at least one image renderer may render 5 reference images R1, R2, R3, R4, and R5. Each of the five reference images R1-R5 represents a cross-shaped white-colored visual target on a dark background. However, different reference images may represent said visual target at different locations and different optical depths. For example, the reference image R1 may represent said visual target at a central portion of the field of view and at an optical depth of D1 units, the reference image R2 may represent said visual target at a top-left portion of the field of view and at an optical depth of D2 units, the reference image R3 may represent said visual target at a top-right portion of the field of view and at an optical depth of D3 units, the reference image R4 may represent said visual target at a bottom-left portion of the field of view and at an optical depth of D4 units, and the reference image R5 may represent said visual target at a bottom-right portion of the field of view and at an optical depth of D5 units.

The at least one processor analyzes the at least one image of the user's eyes that was captured when a given reference image was being rendered, to determine gaze directions of the user's eyes. Herein, the term “at least one image of the user's eyes” refers to “one image of both the user's eyes” in some implementations, and to “separate images of the left eye and the right eye of the user” in other implementations.

It will be appreciated that for every reference image of the sequence of reference images, there is captured at least one image of the user's eyes. In a case when the sequence of reference images comprises a single image, at least one image of the user's eyes would be captured whilst rendering said sequence. In another case when the sequence of reference images comprises a plurality of reference images, a plurality of images of the user's eyes would be captured whilst rendering said sequence.

By analysing the at least one image of the user's eyes, the at least one processor determines a manner in which the user's eyes respond to a visual stimulus (notably, the visual target) provided in the given reference image. Upon said analysis, the gaze directions for both the user's eyes are determined simultaneously. The at least one image of the user's eyes is indicative of where the gaze directions of the user's eyes are directed whilst the user views the given reference image.

It will be appreciated that the gaze directions of user's eyes vary according to location(s) and/or optical depth(s) of the visual target represented in the sequence of reference images. In simpler terms, the gaze directions of the user's eyes follow (namely, are directed towards) the visual target presented in the sequence of reference images. Therefore, by analysing the images of the user's eyes which are captured whilst rendering the sequence of reference images, the at least one processor also determines change in the gaze directions of the user's eyes.

Optionally, the at least one processor is configured to generate a gaze map representative of the location(s) and the optical depth(s) of the visual target in the sequence of reference images and their corresponding determined gaze directions of the user's eyes.

According to an embodiment, when analyzing the at least one image of the user's eyes, the at least one processor is configured to:
identify sizes and shapes of pupils and/or irises of the user's eyes; and
determine, based on the identified sizes and shapes of the pupils and/or the irises, the gaze directions of the user's eyes.

In this regard, the sizes and shapes of the pupils and/or the irises of the user's eyes, as represented in the at least one image of the user's eyes, are indicative of the gaze directions of the user's eyes. Given a known position of the at least one camera with respect to the user's eyes and the identified sizes and shapes of the pupils and/or the irises of the user's eyes, the at least one processor can determine the gaze directions of the user's eyes with considerable accuracy. The position of the at least one camera with respect to the user's eyes is known as it is set while manufacturing the display apparatus. Such a relative position of the at least one camera is indicative of a perspective from which the at least one camera captures the at least one image of the user's eyes. For specific gaze directions of the user's eyes, the identified sizes and shapes of the pupils and/or the irises would be different for different perspectives of capturing the at least one image of the user's eyes. Therefore, the identified sizes and shapes of the pupils and/or the irises, along with knowledge of the position of the at least one camera with respect to the user's eyes allows the at least one processor to accurately determine the gaze directions of the user's eyes.

In an example, the at least one camera may be arranged directly in front of the user's eyes. In a first case, the identified sizes and shapes of the pupils of the user's eyes may correspond to a 5 millimeters diameter and a circular shape, respectively. In such a case, the at least one processor may determine the gaze directions of the user's eyes to be towards the central portion of the field of view. In a second case, the identified sizes and shapes of the pupils of the user's eyes may correspond to a 3 millimeters length and a left-oriented drop shape, respectively. In such a case, the at least one processor may determine the gaze directions of the user's eyes to be towards a right portion of the field of view.

In another example, the at least one camera may be arranged sideways with respect to the user's eyes. The identified sizes and shapes of the pupils of the user's eyes may correspond to 5 millimeters longer diameter and a vertical ellipse shape, respectively. In such a case, the at least one processor may determine the gaze directions of the user's eyes to be towards the central portion of the field of view.

Optionally, the at least one processor is configured to employ at least one image processing algorithm to identify the sizes and shapes of the pupils and/or the irises. Examples of the at least one image processing algorithm include, but are not limited to, an edge detection algorithm, a vertex detection algorithm, a shape-fitting algorithm, and a triangulation-representation algorithm.

Optionally, the at least one processor is configured to:
determine relative sizes of the pupils of the user's eyes with respect to the sizes of the irises of the user's eyes; and
when the relative sizes of the pupils are larger than a predefined threshold, increase a brightness of the at least one image renderer.

Notably, increasing the brightness of the at least one image renderer causes the pupils to constrict and reduce in size. Optionally, the predefined threshold of a maximum acceptable relative size of a pupil with respect to an iris is defined based on generally known parameters of the human eye.

According to another embodiment, the display apparatus further comprises at least one light source that, in operation, emits light to illuminate the user's eyes, wherein, when analyzing the at least one image of the user's eyes, the at least one processor is configured to:
identify relative positions of pupils of the user's eyes with respect to glint patterns formed on the user's eyes by the light emitted from the at least one light source; and
determine, based on the identified relative positions of the pupils, the gaze directions of the user's eyes.

In this regard, the at least one image of the user's eyes represents the user's eyes, as well as reflections of the glint patterns formed on the user's eyes. Notably, the light emitted from the at least one light source forms the glint patterns on surfaces of the user's eyes. These glint patterns are reflected from the surfaces of the user's eyes. The glint patterns act as a frame of reference with respect to which the relative positions of pupils of the user's eyes are identified accurately. As the pupils of the user's eyes are oriented along the gaze directions of the user, the identified relative positions of the pupils allow the at least one processor to accurately determine the gaze directions of the user's eyes.

Optionally, the light emitted from the at least one light source has an infrared wavelength. The glint patterns so formed are infrared glint patterns. Such glint patterns are invisible to the user, and do not cause unwanted distraction when they are formed on the user's eyes. Alternatively, optionally, the light emitted from the at least one light source has a visible wavelength. The glint patterns so formed are visible glint patterns. Such glint patterns are visible to the user. It will be appreciated that the at least one camera is sensitive to a wavelength of the light emitted from the at least one light source.

Throughout the present disclosure, the term “light source” refers to equipment that, in operation, emits light to illuminate the user's eyes. The at least one light source is an infrared light source or a visible-wavelength light source. Examples of the light source include, but are not limited to, a light-emitting diode, a laser diode, a solid-state laser.

Optionally, the glint patterns comprise a plurality of glints. More optionally, an arrangement of the plurality of glints within the glint patterns is known. It will be appreciated that using such glint patterns is especially useful when eyelids of the user are partially closed (for example, when the user blinks or squints his/her eyes). In such cases, portions of the user's eyes and portions of the reflections of the glint pattern may not be visible in the at least one image of the user's eyes. Therefore, given the knowledge of the arrangement of the plurality of glints within the glint pattern, the relative positions of the pupils of the user's eyes can be accurately determined using only those portions of the user's eyes and the reflections of the glint patterns that are visible in the at least one image.

Optionally, the plurality of glints have a same shape and/or size. Alternatively, optionally, the plurality of glints have different shapes and/or sizes.

Optionally, a shape of a given glint is selected from a group consisting of A, V, Y, B, C, D, E, M, T, U and W. It will be appreciated that the shape of the given glint need not necessarily be an alphabetic character, but could also be a number or a pattern that is symmetrical about only one axis and that has rotational uniqueness about 360 degrees.

According to yet another embodiment, when analyzing the at least one image of the user's eyes, the at least one processor is configured to:
identify relative positions of pupils of the user's eyes with respect to corners of the user's eyes; and
determine, based on the identified relative positions of the pupils, the gaze directions of the user's eyes.

In this regard, the corners of the user's eyes are fixed, easily distinguishable features of the user's eyes. Therefore, determining the gaze directions of the user's eyes based on the relative positions of pupils of the user's eyes with respect to corners of the user's eyes allows for improving an accuracy of the detected gaze directions.

Throughout the present disclosure, the term “ocular dominance” refers to a tendency of the user's eyes to prefer visual input from one eye to another eye of the user. A given eye of the user whose visual input is preferred is referred to as a “dominant eye” of the user. In some cases, the ocular dominance of the user may be a normal visual condition of proper functioning of the user's eyes, wherein both eyes of the user have similar visual acuity and one eye is simply preferred over the other eye. In other cases, the ocular dominance of the user may be indicative of an underlying anomalous medical condition which the user suffers from. Such a medical condition may be, for example, constant strabismus or intermittent strabismus. Herein, the term “strabismus” encompasses various types of strabismus, namely, esotropia, exotropia, and hypertropia. Moreover, such a medical condition may also cause other visual disorders such as amblyopia (namely, lazy eye), double vision, convergence insufficiency, and the like. Therefore, it will be appreciated that determining the ocular dominance of the user is extremely important in order to ensure proper calibration of the display apparatus according to the user's eyes, especially for users that suffer from anomalous medical conditions.

The given reference image presents to the user the given visual target at the given location and the given optical depth. Since the at least one processor controls rendering of the given reference image, the given location and the given optical depth is known to the at least one processor. The at least one processor is configured to determine expected gaze directions of the user's eyes, based on the given location and the given optical depth of the given visual target. The at least one processor then compares the expected gaze directions of the user's eyes with the determined gaze directions of the user's eyes to determine which eye of the user acts as the dominant eye at the given optical depth. Notably, an eye of the user for which the expected gaze direction is substantially similar to the determined gaze direction is determined to be the dominant eye of the user.

It will be appreciated that when the sequence of reference images presents the visual target at different optical depths, the at least one processor determines the ocular dominance of the user at the different optical depths.

Moreover, it will be appreciated that the aforesaid processing steps of rendering the sequence of reference images whilst capturing the images of the user's eyes, analyzing the at least one image of the user's eyes to determine the gaze directions of the user's eyes, and determining the ocular dominance of the user form a part of a calibration process of the display apparatus, and therefore, are required to be performed only initially. Upon completion of the calibration process, the display apparatus is operated as usual. Said calibration process is user-specific and can be utilized to provide a seamless usage experience of the display apparatus to all users.

The at least one processor or the imaging unit generates a sequence of extended-reality images to be rendered via the at least one image renderer. Throughout the present disclosure, the term “extended-reality images” encompasses virtual-reality images, augmented-reality image, mixed-reality image, and the like. The extended-reality images provide the user with a digitally-extended (namely, digitally-enhanced) perception of reality around him/her.

Throughout the present disclosure, the term “imaging unit” refers to an equipment configured to generate the extended-reality images for the display apparatus. It will be appreciated that the imaging unit generates the extended-reality images in real time or near real time.

Optionally, the imaging unit is communicably coupled to the display apparatus. By way of such communicable coupling, the imaging unit transmits the generated extended-reality images to the display apparatus. In some implementations, the imaging unit is integrated with the display apparatus. In such implementations, the imaging unit is physically coupled to the display apparatus (for example, attached via mechanical and electrical connections to components of the display apparatus). In other implementations, the imaging unit is implemented on a remote device that is separate from the display apparatus. In such implementations, the imaging unit and the display apparatus are communicably coupled via a wired communication interface or a wireless communication interface. Optionally, the imaging unit is mounted on the remote device. Examples of the remote device include, but are not limited to, a drone, a vehicle, and a robot. In such an instance, the remote device is physically positioned at a given real-world environment, whereas the user of the display apparatus is positioned away from (for example, at a distance from) the remote device.

The sequence of extended-reality images is generated, based on the ocular dominance of the user at the given optical depth. Notably, the gaze direction of the dominant eye at the given optical depth is utilized whilst generating a given extended-reality image. In this way, the given extended-reality image conforms to the gaze direction of the dominant eye of the user. As the visual input from the dominant eye is preferred by the user, the user experiences seamless gaze contingency and considerable realism upon viewing the given extended-reality image. This is especially useful in cases where the user suffers from the anomalous medical condition, as the sequence of extended-reality images is dynamically generated (based on user-specific calibration of the display apparatus) to effectively ameliorate said medical condition.

It will be appreciated that different eyes of the user may act as the dominant eye of the user at different optical depths. In such a case, the given extended-reality image is generated based upon the dominant eye for a current optical depth.

The sequence of extended-reality images is to be rendered via the at least one image renderer. Notably, the sequence of extended-reality images are rendered after the calibration process is complete.

Optionally, the at least one processor or the imaging unit is configured to:
detect whether or not the ocular dominance of the user shifts from a first eye of the user to a second eye of the user with a change in the optical depth; and
when it is detected that the ocular dominance of the user shifts with the change in the optical depth, determine an optical depth at which the ocular dominance of the user shifts from the first eye to the second eye.

Hereinabove, the phrase “ocular dominance of the user shifts from the first eye of the user to the second eye of the user with the change in the optical depth” is used to mean any of:
the dominant eye of the user shifts from the right eye of the user to the left eye of the user with increase or decrease in the optical depth; or
the dominant eye of the user shifts from the left eye of the user to the right eye of the user with increase or decrease in the optical depth.

It will be appreciated that the ocular dominance of the user may or may not change with the change in the optical depth. When the ocular dominance of the user shifts with the change in the optical depth, the optical depth at which the ocular dominance of the user shifts is required to be determined in order to appropriately generate the sequence of extended-reality images according to a current dominant eye of the user at a current optical depth.

Optionally, the change in the optical depth is presented to the user when the identified shapes and/or sizes of the pupils and/or the irises of the user's eyes are asymmetrical. Notably, by analyzing the at least one image of the user's eyes, the at least one processor assesses whether or not both the pupils and/or the irises of the user's eyes exhibit a symmetrical relationship.

As an example, the sequence of reference images may be rendered in a manner that the visual target presented therein appears to move closer to the user. For example, the sequence of reference images may be rendered over a time span of 3.5 seconds in which the visual target appears to move from near-infinity down to a distance of 50 centimeters from the user's eyes. When it is detected that the ocular dominance of the user shifts from the left eye of the user to the right eye of the user with the change in the optical depth of the visual target, the optical depth at which the ocular dominance changes may be determined to be, for example, 100 centimeters. Generally, the display apparatus is calibrated using reference images that present the visual target at near-infinity, but when the aforesaid change in ocular dominance is recorded, another calibration may be performed using reference images that present the visual target at the 50 centimeters distance.

Optionally, the at least one processor is configured to:
control the at least one image renderer to render a given extended-reality image, whilst controlling the at least one camera to capture at least one image of the user's eyes;
analyze the at least one image of the user's eyes to determine gaze directions of the user's eyes; and
identify, based on the gaze directions of the user's eyes, an object of interest presented in the given extended-reality image, wherein the object of interest is presented at a given optical depth within the field of view of the user,

wherein the at least one processor or the imaging unit is configured to:
determine a dominant eye of the user at the given optical depth at which the object of interest is presented; and
generate a subsequent extended-reality image to be rendered via the at least one image renderer, based on a gaze direction of the dominant eye of the user at the given optical depth at which the object of interest is presented.

In this regard, the captured at least one image is representative of how the user's eyes view the given extended-reality image. Said at least one image is analyzed to determine the gaze directions of the user's eyes based on sizes and/or shapes of pupils and/or irises of the user's eyes, relative positions of pupils of the user's eyes with respect to glint patterns formed on the user's eyes, relative positions of pupils of the user's eyes with respect to corners of the user's eyes, or similar. The object of interest is identified as one towards which the gaze directions of the user's eyes are directed. The dominant eye of the user at the given optical depth is determined to be that eye of the user whose determined gaze direction is substantially similar to its expected gaze direction (which is determined based on a known location and optical depth of the object of interest within the field of view). By generating the subsequent extended-reality image based on the gaze direction of the dominant eye of the user at the given optical depth, the at least one processor or the imaging unit ensure that visual input pertaining to the subsequent extended-reality image is effectively received by the human visual system.

For illustration purposes only, there will now be considered that the plurality of reference images, when rendered, present to the user the same visual target initially at near infinity and then at closer optical depths. There will next be considered that the first eye of the user is a dominant eye at optical depths greater than the optical depth at which the ocular dominance shifts, while the second eye of the user is the dominant eye at optical depths equal to or smaller than the optical depth at which the ocular dominance shifts.

In such a case, the at least one processor or the imaging unit is configured to:
generate the subsequent extended-reality image to be rendered via the at least one image renderer based on a gaze direction of the first eye of the user, when the given optical depth of the object of interest is greater than the optical depth at which the ocular dominance shifts; and
generate the subsequent extended-reality image to be rendered via the at least one image renderer based on a gaze direction of the second eye of the user, when the given optical depth of the object of interest is equal to or smaller than the optical depth at which the ocular dominance shifts.

The present disclosure also relates to the method as described above. Various embodiments and variants disclosed above, with respect to the aforementioned first aspect, apply mutatis mutandis to the method.

Optionally, in the method, the sequence of reference images comprises a plurality of reference images that, when rendered, present to the user a same visual target at a same location, but different optical depths, within the field of view of the user.

Optionally, the method further comprises:
detecting whether or not the ocular dominance of the user shifts from a first eye of the user to a second eye of the user with a change in the optical depth; and
when it is detected that the ocular dominance of the user shifts with the change in the optical depth, determining an optical depth at which the ocular dominance of the user shifts from the first eye to the second eye.

Optionally, the method further comprises:
rendering a given extended-reality image, whilst capturing at least one image of the user's eyes;
analyzing the at least one image of the user's eyes to determine gaze directions of the user's eyes;
identifying, based on the gaze directions of the user's eyes, an object of interest presented in the given extended-reality image, wherein the object of interest is presented at a given optical depth within the field of view of the user;
determining a dominant eye of the user at the given optical depth at which the object of interest is presented; and
generating a subsequent extended-reality image to be rendered, based on a gaze direction of the dominant eye of the user at the given optical depth at which the object of interest is presented.

Optionally, in the method, the step of analyzing the at least one image of the user's eyes comprises:
identifying sizes and shapes of pupils and/or irises of the user's eyes; and
determining, based on the identified sizes and shapes of the pupils and/or the irises, the gaze directions of the user's eyes.

Optionally, the method further comprises emitting light to illuminate the user's eyes, wherein the step of analyzing the at least one image of the user's eyes comprises:
identifying relative positions of pupils of the user's eyes with respect to glint patterns formed on the user's eyes by the emitted light; and
determining, based on the identified relative positions of the pupils, the gaze directions of the user's eyes.

Optionally, in the method, the step of analyzing the at least one image of the user's eyes comprises:
identifying relative positions of pupils of the user's eyes with respect to corners of the user's eyes; and
determining, based on the identified relative positions of the pupils, the gaze directions of the user's eyes.

### DETAILED DESCRIPTION OF THE DRAWINGS

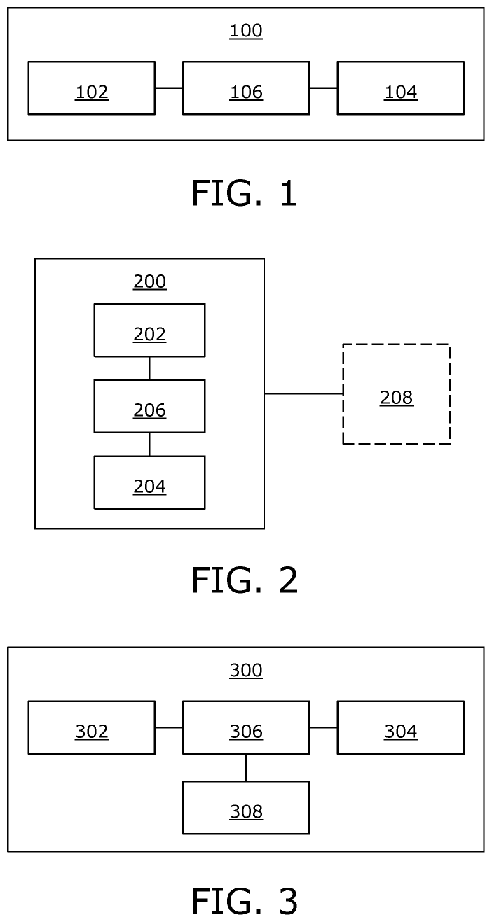

Referring to FIG. 1, illustrated is a block diagram of architecture of a head-mounted display apparatus 100, in accordance with an embodiment of the present disclosure. The head-mounted display apparatus 100 comprises at least one image renderer (depicted as an image renderer 102), at least one camera (depicted as a camera 104), and at least one processor (depicted as a processor 106).

The processor 106 is configured to:
control the image renderer 102 to render a sequence of reference images, whilst controlling the camera 104 to capture images of a user's eyes, wherein each reference image of said sequence presents to the user a visual target at a corresponding location and a corresponding optical depth within a field of view of the user;
analyze at least one image of the user's eyes that was captured when a given reference image was being rendered, to determine gaze directions of the user's eyes; and
determine, based on the determined gaze directions of the user's eyes and a given location of a given visual target within the field of view presented by the given reference image, an ocular dominance of the user at a given optical depth at which the given visual target was being presented by the given reference image,
   wherein the processor 106 is configured to generate, based on the ocular dominance of the user at the given optical depth, a sequence of extended-reality images to be rendered via the image renderer 102.

Referring to FIG. 2, illustrated is a block diagram of architecture of a head-mounted display apparatus 200, in accordance with another embodiment of the present disclosure. The head-mounted display apparatus 200 comprises at least one image renderer (depicted as an image renderer 202), at least one camera (depicted as a camera 204), and at least one processor (depicted as a processor 206).

The processor 206 is configured to:
control the image renderer 202 to render a sequence of reference images, whilst controlling the camera 204 to capture images of a user's eyes, wherein each reference image of said sequence presents to the user a visual target at a corresponding location and a corresponding optical depth within a field of view of the user;
analyze at least one image of the user's eyes that was captured when a given reference image was being rendered, to determine gaze directions of the user's eyes; and
determine, based on the determined gaze directions of the user's eyes and a given location of a given visual target within the field of view presented by the given reference image, an ocular dominance of the user at a given optical depth at which the given visual target was being presented by the given reference image,
   wherein an imaging unit 208 communicably coupled to the processor 206 is configured to generate, based on the ocular dominance of the user at the given optical depth, a sequence of extended-reality images to be rendered via the image renderer 202.

Referring to FIG. 3, illustrated is a block diagram of architecture of a head-mounted display apparatus 300, in accordance with another embodiment of the present disclosure. The head-mounted display apparatus 300 comprises at least one image renderer (depicted as an image renderer 302), at least one camera (depicted as a camera 304), and at least one processor (depicted as a processor 306). The head-mounted display apparatus 300 further comprises at least one light source (depicted as a light source 308) that, in operation, emits light to illuminate the user's eyes. When analyzing at least one image of a user's eyes, the processor 306 is configured to:
identify relative positions of pupils of the user's eyes with respect to glint patterns formed on the user's eyes by the light emitted from the light source 308; and
determine, based on the identified relative positions of the pupils, gaze directions of the user's eyes.

It may be understood by a person skilled in the art that FIG. 1, FIG. 2 and FIG. 3 include simplified architectures of the head-mounted display apparatuses 100, 200 and 300, respectively, for sake of clarity, which should not unduly limit the scope of the claims herein. The person skilled in the art will recognize many variations, alternatives, and modifications of embodiments of the present disclosure.

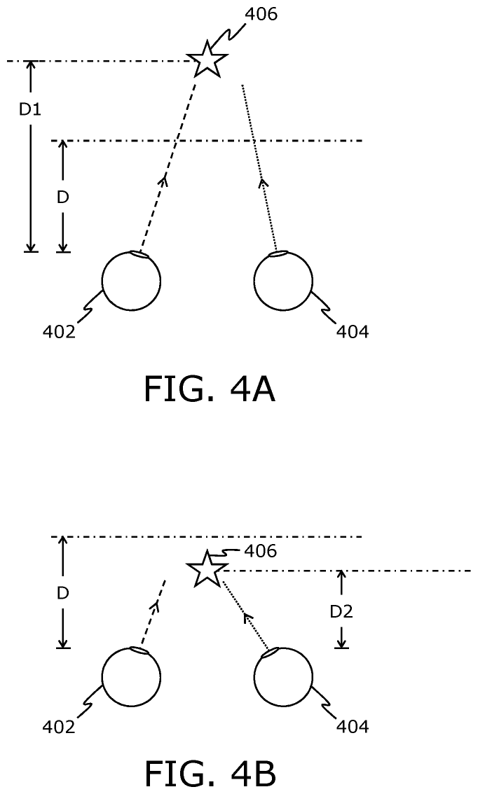

Referring to FIGS. 4A and 4B, illustrated is ocular dominance of a user's eyes 402 and 404, in accordance with an embodiment of the present disclosure. In FIGS. 4A and 4B, a left eye of the user is depicted as eye 402, whereas a right eye of the user is depicted as eye 404. Moreover, a gaze direction of the left eye 402 of the user is indicated by way of a dashed line, whereas a gaze direction of the right eye 404 of the user is indicated by way of a dotted line.

In FIG. 4A, a visual target 406 is presented at an optical depth D1 that is greater than an optical depth D. At the optical depth D1, the left eye 402 of the user is dominant (namely, acts as a dominant eye of the user). Notably, in such a case, the gaze direction of the left eye 402 is precisely directed towards the visual target 406, whereas the gaze direction of the right eye 404 is relatively misaligned with respect to the visual target 406.

In FIG. 4B, the visual target 406 is presented at an optical depth D2 that is smaller than the optical depth D. At the optical depth D2, the right eye 404 of the user is dominant. Notably, in such a case, the gaze direction of the right eye 404 is precisely directed towards the visual target 406, whereas the gaze direction of the left eye 402 is relatively misaligned with respect to the visual target 406.

The ocular dominance of the user at any given optical depth within a field of view of the user can be determined based on the gaze directions of the user's eyes 402 and 404. In FIGS. 4A and 4B, the ocular dominance of the user is shown to shift with change in optical depth. As shown, the left eye 402 is dominant at optical depths greater than D, whereas the right eye 404 is dominant at optical depths equal to or smaller than D. In particular, the optical depth D indicates the optical depth at which the ocular dominance of the user shifts from the left eye 402 to the right eye 404, or vice versa.

It may be understood by a person skilled in the art that FIGS. 4A and 4B include simplified illustrations of ocular dominance for sake of clarity, which should not unduly limit the scope of the claims herein. The person skilled in the art will recognize many variations, alternatives, and modifications of embodiments of the present disclosure.

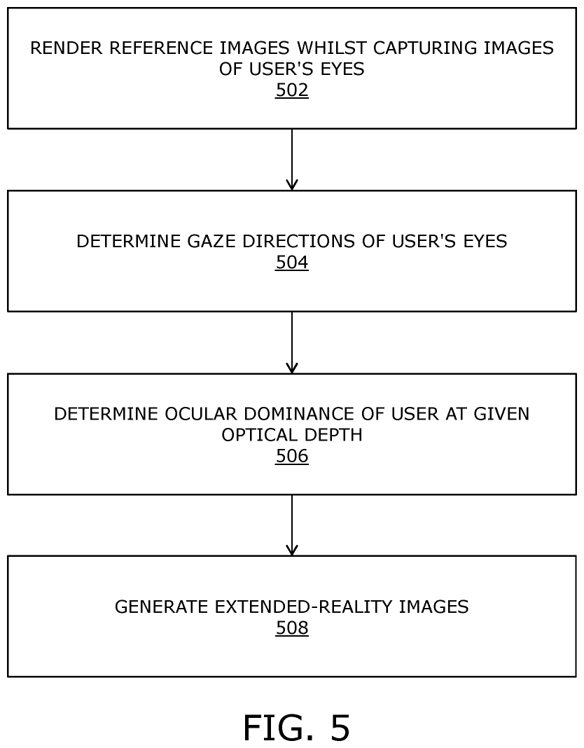

Referring to FIG. 5, illustrated are steps of a method, in accordance with an embodiment of the present disclosure. At step 502, a sequence of reference images is rendered whilst capturing images of a user's eyes. Each reference image of said sequence presents to the user a visual target at a corresponding location and a corresponding optical depth within a field of view of the user. At step 504, at least one image of the user's eyes that was captured when a given reference image was being rendered is analyzed, to determine gaze directions of the user's eyes. At step 506, an ocular dominance of the user at a given optical depth at which the given visual target was being presented by the given reference image is determined, based on the determined gaze directions of the user's eyes and a given location of a given visual target within the field of view presented by the given reference image. At step 508, a sequence of mixed-reality images to be rendered is generated, based on the ocular dominance of the user at the given optical depth.

The steps 502 to 508 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A head-mounted display apparatus comprising:
at least one image renderer;
at least one camera; and
at least one processor configured to:
control the at least one image renderer to render a sequence of reference images, whilst controlling the at least one camera to capture images of a user's eyes , wherein each reference image of said sequence presents to the user a visual target at a corresponding location and a corresponding optical depth within a field of view of the user;
analyze at least one image of the user's eyes that was captured when a given reference image was being rendered, to determine gaze directions of the user's eyes; and
determine, based on the determined gaze directions of the user's eyes and a given location of a given visual target within the field of view presented by the given reference image, an ocular dominance of the user at a given optical depth at which the given visual target was being presented by the given reference image,
wherein the at least one processor or an imaging unit communicably coupled to the at least one processor is configured to generate, based on the ocular dominance of the user at the given optical depth, a sequence of extended-reality images to be rendered via the at least one image renderer.

2. The display apparatus of claim 1, wherein the sequence of reference images comprises a plurality of reference images that, when rendered, present to the user a same visual target at a same location, but different optical depths, within the field of view of the user.

3. The display apparatus of claim 1, wherein the at least one processor or the imaging unit is configured to:
detect whether or not the ocular dominance of the user shifts from a first eye of the user to a second eye of the user with a change in the optical depth; and
when it is detected that the ocular dominance of the user shifts with the change in the optical depth, determine an optical depth at which the ocular dominance of the user shifts from the first eye to the second eye.

4. The display apparatus of claim 1, wherein the at least one processor is configured to:
control the at least one image renderer to render a given extended-reality image, whilst controlling the at least one camera to capture at least one image of the user's eyes;
analyze the at least one image of the user's eyes to determine gaze directions of the user's eyes; and
identify, based on the gaze directions of the user's eyes, an object of interest presented in the given extended-reality image, wherein the object of interest is presented at a given optical depth within the field of view of the user,
wherein the at least one processor or the imaging unit is configured to:
determine a dominant eye of the user at the given optical depth at which the object of interest is presented; and
generate a subsequent extended-reality image to be rendered via the at least one image renderer, based on a gaze direction of the dominant eye of the user at the given optical depth at which the object of interest is presented.

5. The display apparatus of claim 1, wherein, when analyzing the at least one image of the user's eyes, the at least one processor is configured to:
identify sizes and shapes of pupils and/or irises of the user's eyes; and
determine, based on the identified sizes and shapes of the pupils and/or the irises, the gaze directions of the user's eyes.

6. The display apparatus of claim 1, further comprising at least one light source that, in operation, emits light to illuminate the user's eyes, wherein, when analyzing the at least one image of the user's eyes, the at least one processor is configured to:
identify relative positions of pupils of the user's eyes with respect to glint patterns formed on the user's eyes by the light emitted from the at least one light source; and
determine, based on the identified relative positions of the pupils, the gaze directions of the user's eyes.

7. The display apparatus of claim 1, wherein, when analyzing the at least one image of the user's eyes, the at least one processor is configured to:
identify relative positions of pupils of the user's eyes with respect to corners of the user's eyes; and
determine, based on the identified relative positions of the pupils, the gaze directions of the user's eyes.

8. A method comprising:
rendering a sequence of reference images, whilst capturing images of a user's eyes, wherein each reference image of said sequence presents to the user a visual target at a corresponding location and a corresponding optical depth within a field of view of the user;
analyzing at least one image of the user's eyes that was captured when a given reference image was being rendered, to determine gaze directions of the user's eyes;
determining, based on the determined gaze directions of the user's eyes and a given location of a given visual target within the field of view presented by the given reference image, an ocular dominance of the user at a given optical depth at which the given visual target was being presented by the given reference image; and
generating, based on the ocular dominance of the user at the given optical depth, a sequence of extended-reality images to be rendered.

9. The method of claim 8, wherein the sequence of reference images comprises a plurality of reference images that, when rendered, present to the user a same visual target at a same location, but different optical depths, within the field of view of the user.

10. The method of claim 8, further comprising:
detecting whether or not the ocular dominance of the user shifts from a first eye of the user to a second eye of the user with a change in the optical depth; and
when it is detected that the ocular dominance of the user shifts with the change in the optical depth, determining an optical depth at which the ocular dominance of the user shifts from the first eye to the second eye.

11. The method of claim 8, further comprising:
rendering a given extended-reality image, whilst capturing at least one image of the user's eyes;
analyzing the at least one image of the user's eyes to determine gaze directions of the user's eyes;
identifying, based on the gaze directions of the user's eyes, an object of interest presented in the given extended-reality image, wherein the object of interest is presented at a given optical depth within the field of view of the user;
determining a dominant eye of the user at the given optical depth at which the object of interest is presented; and
generating a subsequent extended-reality image to be rendered, based on a gaze direction of the dominant eye of the user at the given optical depth at which the object of interest is presented.

12. The method of claim 8, wherein the step of analyzing the at least one image of the user's eyes comprises:
identifying sizes and shapes of pupils and/or irises of the user's eyes; and
determining, based on the identified sizes and shapes of the pupils and/or the irises, the gaze directions of the user's eyes.

13. The method of claim 8, further comprising emitting light to illuminate the user's eyes, wherein the step of analyzing the at least one image of the user's eyes comprises:
identifying relative positions of pupils of the user's eyes with respect to glint patterns formed on the user's eyes by the emitted light; and
determining, based on the identified relative positions of the pupils, the gaze directions of the user's eyes.

14. The method of claim 8, wherein the step of analyzing the at least one image of the user's eyes comprises:
identifying relative positions of pupils of the user's eyes with respect to corners of the user's eyes; and
determining, based on the identified relative positions of the pupils, the gaze directions of the user's eyes.
